(19) United States
(12) Patent Application Publication
(10) Pub. No.: US 2015/0269695 A1
(43) Pub. Date: Sep. 24, 2015

(54) SYSTEMS AND METHODS FOR IDENTIFYING FINANCIAL ASSISTANCE OPPORTUNITIES FOR MEDICATIONS AS PART OF THE PROCESSING OF A HEALTHCARE TRANSACTION

(71) Applicant: McKesson Financial Holdings, Hamilton (BM)

(72) Inventors: Roger G. Pinsonneault, Alpharetta, GA (US); James C. Rowe, Sugar Hill, GA (US)

(73) Assignee: MCKESSON FINANCIAL HOLDINGS, Hamilton (BM)

(21) Appl. No.: 14/218,326

(22) Filed: Mar. 18, 2014

(51) Int. Cl. G06Q 50/22; G06Q 30/02

(52) U.S. Cl. CPC G06Q 50/22; G06Q 30/0207

(57) ABSTRACT

Systems and methods are provided for identifying non-insurance related financial assistance opportunities for patients as part of the processing of a healthcare transaction. Upon receiving a healthcare transaction from a healthcare provider, the service provider can identify non-insurance related financial assistance opportunities for the patient. The service provider can reject the transaction and transmit the rejection along with a message identifying the non-insurance related financial assistance opportunity to the healthcare provider and await a resubmitted healthcare transaction. In other examples, the service provider can process the healthcare transaction and include a message or code identifying the financial assistance opportunity in the healthcare transaction or an adjudicated response to the healthcare transaction. In another example, the service provider can identify contact information for the patient identified in the healthcare transaction and can transmit a message identifying the non-insurance related financial assistance opportunity directly to the patient via the contact information.

### TECHNICAL FIELD

Aspects of the disclosure relate generally to determination of financial assistance opportunities for patients, and more particularly, to systems and methods for determining if non-insurance related financial assistance is available for a patient receiving a medication and notifying the patient of the financial assistance opportunities available as part of the processing of a healthcare transaction.

### BACKGROUND

In many cases, when a healthcare patient completes a visit to a physician or other healthcare provider, the patient is prescribed a medication or other product as part of the overall health regimen. As healthcare costs have increased, many patients have decided to forgo filling these prescriptions or refilling these prescriptions as a way to save money. This however, results in the patient not completing the therapeutic regimen identified by their healthcare provider.

In an effort to assist patients with ways to defray at least a portion of their healthcare costs, manufacturers and marketers of medications and other products can, from time-to-time offer non-insurance related financial assistance programs (e.g., an incentive program, such as a coupon, voucher, rebate, discount, loyalty award, or other equivalent non-insurance benefit or the like) to patients. While these programs can help a patient defray some of the cost, this can only be done if the patient is actually aware that the program exists.

### BRIEF DESCRIPTION OF THE DRAWINGS

Reference will now be made to the accompanying drawings, which are not necessarily drawn to scale, and wherein:

FIG. 1 illustrates an example overview of a system that facilitates determining if non-insurance related financial assistance is available for a patient receiving a medication and notifying the patient of the financial assistance opportunities available as part of the processing of a healthcare transaction, according to one exemplary embodiment of the disclosure.

FIG. 2A is a diagram of an example data flow for determining if non-insurance related financial assistance is available for a patient receiving a medication and notifying the patient of the financial assistance opportunities available as part of the processing of a healthcare transaction, according to one exemplary embodiment of the disclosure.

FIG. 2B is a diagram of another example data flow for determining if non-insurance related financial assistance is available for a patient receiving a medication and notifying the patient of the financial assistance opportunities available as part of the processing of a healthcare transaction, according to an alternative exemplary embodiment of the disclosure.

FIG. 3 is a flow chart of an example method for determining if non-insurance related financial assistance is available for a patient receiving a medication as part of the processing of a healthcare transaction, according to one exemplary embodiment of the disclosure.

FIG. 4 is a flow chart of one example method for notifying the patient of the financial assistance opportunities available as part of the processing of a healthcare transaction, according to one exemplary embodiment of the disclosure.

FIG. 5 is a flow chart of another example method for notifying the patient of the financial assistance opportunities available as part of the processing of a healthcare transaction, according to one exemplary embodiment of the disclosure.

FIG. 6 is a flow chart of yet another example method for notifying the patient of the financial assistance opportunities available as part of the processing of a healthcare transaction, according to one exemplary embodiment of the disclosure.

FIG. 7 is a flow chart of another example method for determining if non-insurance related financial assistance is available for a patient receiving a medication and notifying the patient of the financial assistance opportunities available as part of the processing of a healthcare transaction, according to an alternative exemplary embodiment of the disclosure.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate the determination as to whether non-insurance related financial assistance, (e.g., an incentive program) is available for a patient receiving a medication and notifying the patient of the financial assistance opportunities available as part of the processing of a healthcare transaction in real-time or near real-time. In certain situations, the incentive program is being provided by the company that manufactures or markets the product or service that the patient is being prescribed and will be receiving. For example, a pharmacy or other healthcare provider can transmit a healthcare transaction (e.g., eligibility verification request, predetermination of benefits transaction, healthcare claim transaction, prescription claim or billing request, healthcare order transaction, or e-prescription transaction (i.e., electronic prescription order transaction, e-script, or e-prescription)) for adjudication. The healthcare transaction can be for a prescribed medication or product (hereinafter collectively referred to as “medication”) for a patient. In one example, the healthcare transaction can be received by the service provider computer and, based on information in the transaction, the service provider computer can determine the claims processor computer to adjudicate the transaction or another destination receiver of the transaction. For situations where the healthcare transaction is a form of billing transaction, the service provider computer transmits the healthcare transaction to that determined claims processor computer for adjudication. For situations where the healthcare transaction is an e-prescription transaction (i.e., electronic prescription order transaction, e-script, or e-prescription), the service provider computer transmits the healthcare transaction to the determined destination receiver, such as a pharmacy.

With regard to examples where the healthcare transaction is a form of billing transaction, the claims processor computer adjudicates the healthcare transaction and transmits back to the service provider computer an adjudicated healthcare transaction response. Either prior to sending the healthcare transaction to the claims processor computer or after receiving the adjudicated response from the claims processor computer, the service provider computer can determine if the healthcare transaction qualifies for patient financial assistance evaluation and if an incentive program or other non-insurance based financial assistance is available to the patient. In one example embodiment, an incentive program can include, but is not limited to, a coupon, voucher, rebate, discount, loyalty award, or other equivalent non-insurance benefit or the like.

If the adjudication is an approval or paid response for the healthcare transaction, the service provider computer and the patient qualifies for non-insurance based financial assistance, the service provider computer can determine how to provide information about the non-insurance based financial assistance to the patient. For example, the service provider computer may insert the non-insurance based financial assistance availability information into the adjudicated healthcare claim response. In another example, the service provider computer may generate a separate message containing the non-insurance based financial assistance availability information and can append the generated message to the adjudicated healthcare transaction response. In yet another example, the service provider computer can generate a message containing the non-insurance based financial assistance availability information and can send that message directly to the patient (e.g., via email, voice mail, text message or the like). In yet another example, the service provider computer may initially reject the healthcare transaction prior to sending it to the claims processor computer for adjudication. The rejection may be transmitted to a pharmacy computer from the service provider computer. The rejection can include the non-insurance based financial assistance availability information and an override code. The override code can be used in a second healthcare transaction and can identify that the pharmacist or employee thereof has seen the financial assistance information and is aware of it for subsequent communication to the patient.

Upon receipt of the adjudicated healthcare transaction response from the claims processor computer, the service provider computer can determine how to communicate the non-insurance based financial assistance availability information to the patient, as discussed above, and then can forward the adjudicated healthcare transaction response to the pharmacy computer. The pharmacy computer can receive the adjudicated healthcare transaction response. If non-insurance based financial assistance availability information is included or appended to the adjudicated response, that information can be printed out based on a coded format or can otherwise be provided to the patient (e.g., added to the interior/exterior of the prescription bag, etc.).

System Overview

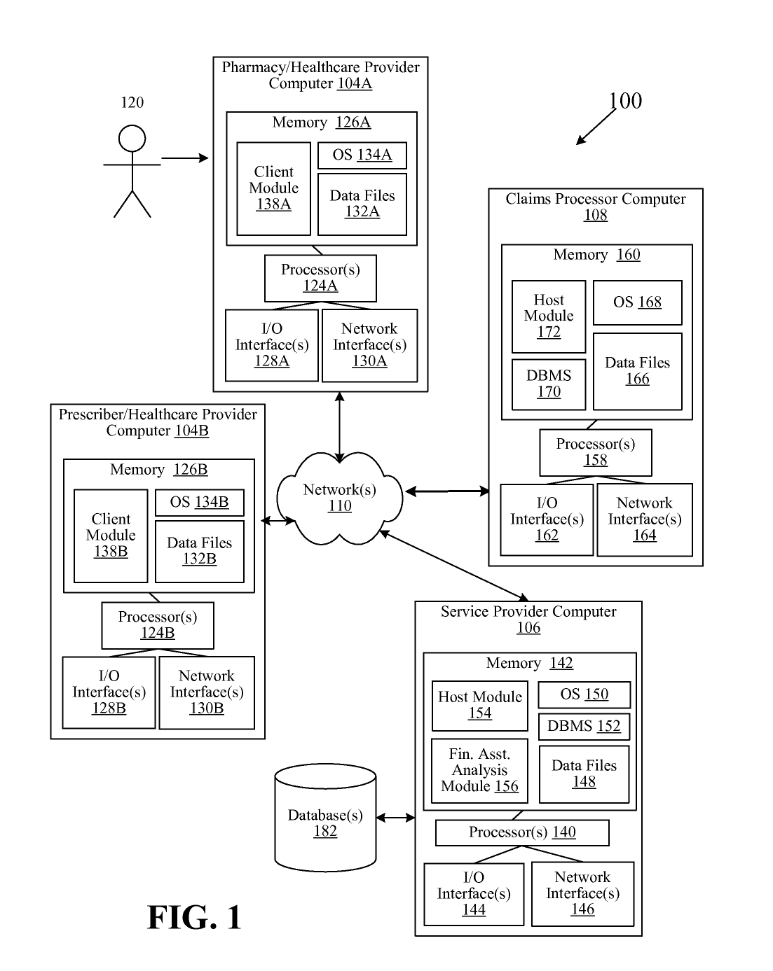

FIG. 1 illustrates an example system 100 supporting healthcare transactions, electronic prescription ordering activities, prescription billing activities, and patient coverage eligibility verifications according to one example embodiment. The exemplary system 100 facilitates determining if non-insurance related financial assistance is available for a patient receiving a medication and notifying the patient of the financial assistance opportunities available as part of the processing of a healthcare transaction, including, but not limited to, an eligibility verification request, predetermination of benefits transaction, healthcare claim transaction, prescription claim or billing request, healthcare order transaction, or e-prescription transaction (i.e., electronic prescription order transaction, e-script, or e-prescription), and will now be described illustratively with respect to FIG. 1.

As shown in FIG. 1, the system 100 may include at least one healthcare provider computer 104, at least one service provider computer 106, and at least one claims processor computer 108. As shown in FIG. 1, multiple healthcare provider computers 104A and 104B are presented by way of example and may be referred to individually or collectively as “healthcare provider computer 104” hereinafter. Alternatively, each of the pharmacy/healthcare provider computer 104A and prescriber/healthcare provider computer 104B may be specifically discussed with reference to designations on FIG. 1.

As desired, each of the healthcare provider computers 104A and 104B, service provider computer 106, and/or claims processor computers 108 may include one or more processing devices that may be configured for accessing and reading associated computer-readable transitory or non-transitory media having stored thereon data and/or computer-executable instructions for implementing the various methods of the disclosure.

Generally, network devices and systems, including one or more of the healthcare provider computers 104A and 104B, service provider computer 106, and claims processor computer 108 may include or otherwise be associated with suitable hardware and/or software for transmitting and receiving data and/or computer-executable instructions over one or more communications links or networks. These network devices and systems may also include any number of processors for processing data and executing computer-executable instructions, as well as other internal and peripheral components that are well known in the art. Further, these network devices and systems may include or be in communication with any number of suitable memory devices operable to store data and/or computer-executable instructions. By executing computer-executable instructions, each of the network devices may form a special purpose computer or particular machine. As used herein, the term “computer-readable medium” describes any form of suitable memory or memory device.

As shown in FIG. 1, the healthcare provider computers 104A and 104B, service provider computer 106, and claims processor computer 108 may be in communication with each other via one or more networks, such as network 110, which as described below can include one or more separate or shared private and public networks, including the Internet or a publicly switched telephone network. Each of these components—the healthcare provider computers 104A and 104B, service provider computer 106, claims processor computer 108, and the network 110 will now be discussed in further detail.

Each healthcare provider computer 104 may be associated with (e.g., located within) a healthcare provider, such as, for example, a prescriber (such as a doctor, dentist, hospital, physician's office, urgent care center, anyone legally permitted to prescribe medications) or pharmacy (e.g., including pharmacies within hospitals and care centers, etc.). While the exemplary healthcare provider computers 104A and 104B reference a pharmacy (104A) and a prescriber of medication (104B) this is for example only and is not intended to be limiting in any manner. Each healthcare provider computer 104A and 104B may be any suitable processor-driven device that facilitates the processing of healthcare requests made by patients or consumers and the communication of information associated with healthcare transactions to the service provider computer 106, such as a server computer, a mainframe computer, one or more networked computers, a desktop computer, a personal computer, a digital assistant, a personal digital assistant, a digital tablet, an Internet appliance, an application-specific circuit, microcontroller, minicomputer, or any other processor-based device. In certain example embodiments, each healthcare provider computer 104A and 104B may be a suitable point of sale device associated with a healthcare provider. The execution of the computer-implemented instructions by either healthcare provider computer 104A and 104B may form a special purpose computer or other particular machine that is operable to facilitate the processing of healthcare requests made by patients and the communication of information associated with healthcare transactions to a service provider computer 106. Additionally, in certain exemplary embodiments, the operations and/or control of each healthcare provider computer 104A and 104B may be distributed amongst several processing components.

In addition to each having one or more processors 124A and 124B, each healthcare provider computer 104A and 104B may include one or more memory devices 126A and 126B, one or more input/output (“I/O”) interface(s) 128A and 128B, and one or more network interface(s) 130A and 130B. The memory devices 126A and 126B may be any suitable memory device, for example, caches, read only memory devices, random access memory devices, magnetic storage devices, removable storage devices, etc. The memory devices 126A and 126B may store data, executable instructions, and/or various program modules utilized by each healthcare provider computer 104A and 104B, for example, data files 132A and 132B, an operating system (“OS”) 134A and 134B, and/or a client module 138A and 138B, respectively. Each of the data files 132A and 132B may include any suitable data that facilitates the receipt and/or processing of healthcare requests by the respective healthcare provider computer 104A and 104B and the generation and/or processing of healthcare transactions that are communicated to the service provider computer 106. For example, the data files 132A and 132B may include, but are not limited to, healthcare information and/or contact information associated with one or more patients, information associated with the particular healthcare provider and/or the respective healthcare provider computer 104A and 104B, information associated with the service provider computer 106, information associated with one or more claims processors and claims processor computers 108, and/or information associated with one or more healthcare transactions. The OS 134A and 134B may be any suitable software module that controls the general operation of the respective healthcare provider computer 104A and 104B. The OS 134A and 134B may also facilitate the execution of other software modules by the one or more respective processors 124A and 124B, for example, the client module 138A and 138B. The OS 134A and 134B may be and currently existing or future-developed operating system including, but not limited to, Microsoft Windows®, Apple OSX™, Linux, Unix, or a mainframe operating system.

Each client module 138A and 138B may be an Internet browser or other suitable software, including a dedicated program, for interacting with the service provider computer 106. For example, a user 120 such as a pharmacist, pharmacy assistant, nurse practitioner, physician, nurse, or other pharmacy, hospital or physician's office employee or any other persons associated with a prescriber, pharmacy, or healthcare provider may utilize the respective client module 138A and 138B in preparing and providing a healthcare transaction, such as an eligibility verification request, predetermination of benefits transaction, healthcare claim transaction, prescription claim or billing request, healthcare order transaction, or e-prescription transaction (i.e., electronic prescription order transaction, e-script, or e-prescription), to the service provider computer 106 for delivery to: the appropriate claims processor computer 108 or other third-party for adjudication or other coverage/benefits determination, or to the appropriate pharmacy computer 104A (e.g., e-prescription transaction (i.e., electronic prescription order transaction, e-script, or e-prescription)) to fill a prescription transmitted by the prescriber computer 104B. Each healthcare provider computer 104A and 104B may also utilize the respective client module 138A and 138B to retrieve or otherwise receive data, messages, or responses from the service provider computer 106 and/or other components of the system 100. For example, in certain embodiments, the client module 138A and 138B may be utilized to receive and/or transmit a healthcare transaction and/or receive an adjudicated healthcare transaction response from the service provider computer 106 as will be described below.

The one or more I/O interfaces 128A and 128B may facilitate communication between the respective healthcare provider computer 104A and 104B and one or more input/output devices, for example, one or more user interface devices, such as, a display, keypad, control panel, touch screen display, remote control, microphone, etc. that facilitate user interaction with the particular healthcare provider computer 104A and 104B. For example, the one or more I/O interfaces 128A and 128B may facilitate entry of information associated with a healthcare transaction by an employee 120 of a healthcare provider, such as a pharmacy employee, pharmacist, physician, nurse, hospital employee, or nurse practitioner affiliated with a pharmacy, hospital, physician's office or other similar healthcare provider. The one or more network interfaces 130A and 130B may facilitate connection of the particular healthcare provider computer 104A and 104B to one or more suitable networks, for example, the network 110 illustrated in FIG. 1. In this regard, each healthcare provider computer 104A and 104B may receive and/or communicate information to other network components of the system 100, such as the service provider computer 106.

With continued reference to FIG. 1, the service provider computer 106 may include, but is not limited to, any suitable processor-driven device that is configured for receiving, processing, and fulfilling information and/or requests from the healthcare provider computers 104A and 104B, and/or the claims processor computer 108 relating to pharmacy, benefits, billing, electronic prescription submission, and/or other healthcare transactions and/or other activities. In certain exemplary embodiments, the service provider computer 106 may be a switch/router that routes healthcare transactions and/or other healthcare requests. For example, the service provider computer 106 may route healthcare transactions communicated from one of the healthcare provider computers 104A and 104B to a claims processor computer 108, such as a pharmacy benefits manager (PBM), an insurer, a Medicare payor, or other third-party payor. In addition, the service provider computer 106 may route healthcare transactions communicated from the prescriber computer 104B to the pharmacy computer 104A.

In certain example embodiments, the service provider computer 106 may include a suitable host server, host module, or other software that facilitates the receipt of a healthcare transaction from a healthcare provider computer 104A or 104B and/or the routing of the received healthcare transaction to a claims processor computer 108 or pharmacy computer 104A. Any number of healthcare provider computers 104A and 104B, and/or claims processor computers 108 may be in communication with the service provider computer 106 as desired in various embodiments.

The service provider computer 106 may include any number of special purpose computers or other particular machines, application-specific circuits, microcontrollers, personal computers, minicomputers, mainframe computers, servers, networked computers, and/or other processor-driven devices. In certain example embodiments, the operations of the service provider computer 106 may be controlled by computer-executed or computer-implemented instructions that are executed by one or more processors associated with the service provider computer 106 to form a special purpose computer or other particular machine that is operable to facilitate the receipt, routing, and/or processing of healthcare transactions. The one or more processors that control the operations of the service provider computer 106 may be incorporated into the service provider computer 106 and/or in communication with the service provider computer 106 via one or more suitable networks. In certain exemplary embodiments, the operations and/or control of the service provider computer 106 may be distributed amongst several processing components.

Similar to the healthcare provider computers 104A and 104B described above, the service provider computer 106 may include one or more processors 140, one or more memory devices 142, one or more input/output (“I/O”) interface(s) 144, and one or more network interface(s) 146. The one or more memory devices 142 may be any suitable memory devices, for example, caches, read only memory devices, random access memory devices, magnetic storage devices, removable memory devices, etc. The one or more memory devices 142 may store data, executable instructions, and/or various program modules utilized by the service provider 106, for example, data files 148, an operating system (“OS”) 150, the host module 154, a service provider module 156, and a database management system (“DBMS”) 152 to facilitate management of data files 148 and other data stored in the memory devices 142. The OS 150 may be any currently existing or future-developed operating system including, but not limited to, Microsoft Windows®, Apple OSX™, Linux, Unix, or a mainframe operating system. The OS 150 may be a suitable software module that controls the general operation of the service provider computer 106 and/or that facilitates the execution of other software modules.

The financial assistance analysis module 156 may be operable to perform one or more pre-edits or pre-analysis, including, but not limited to, determining if a medication qualifies for non-insurance related financial assistance, determining if a healthcare provider associated with the healthcare provider computer 104A or 104B has contracted to receive non-insurance related financial assistance analysis for its patients/customers, determining if non-insurance related financial assistance is permitted for the particular healthcare transaction and determining how to provide the non-insurance related financial assistance information to the patient. Additionally, the financial assistance analysis module 156 may be operable to perform one or more post-edits on an adjudicated response that is received from a claims processor computer 108 for a healthcare transaction prior to routing the adjudicated response to one of the healthcare provider computers 104A and 104B. In one example embodiment, the post edits can include, but are not limited to, any of determining if a medication qualifies for non-insurance related financial assistance, determining if a healthcare provider associated with the healthcare provider computer 104A or 104B has contracted to receive non-insurance related financial assistance analysis for its patients/customers, determining if non-insurance related financial assistance is permitted for the particular healthcare transaction and determining how to provide the non-insurance related financial assistance information to the patient previously described as being conducted as pre-edits. A wide variety of different pre-edits and/or post-edits may be performed as desired in various embodiments of the disclosure.

According to one exemplary embodiment, the data files 148 may store healthcare transaction records associated with communications received from various healthcare provider computers 104A and 104B and/or various claims processor computers 108. The data files 148 may also store any number of suitable routing tables that facilitate determining the destination of communications received from a healthcare provider computer 104A and 104B or claims processor computer 108. The data files 148 may further store information about non-insurance related financial assistance program opportunities available for different medications and the parameters, if any, necessary to satisfy each program.

The host module 154 may receive, process, and respond to requests from the client module 138 of one of the healthcare provider computers 104A and 104B, and may further receive, process, and respond to requests of the host module 172 of the claims processor computer 108. The service provider computer 106 may include additional program modules for performing other processing methods described herein. Those of ordinary skill in the art will appreciate that the service provider computer 106 may include alternate and/or additional components, hardware or software without departing from exemplary embodiments of the invention.

With continued reference to the service provider computer 106, the one or more I/O interfaces 144 may facilitate communication between the service provider computer 106 and one or more input/output devices, for example, one or more user interface devices, such as a display, keypad, control panel, touch screen display, remote control, microphone, etc. that facilitate user interaction with the service provider computer 106. The one or more network interfaces 146 may facilitate connection of the service provider computer 106 to one or more suitable networks, for example, the network 110 illustrated in FIG. 1. In this regard, the service provider computer 106 may communicate with other components of the system 100.

The database(s) 182 may be operable to store information about non-insurance related financial assistance program opportunities available for different medications and the parameters, if any, necessary to satisfy each program including but not limited to, opportunities based on the gender of the patient, opportunities based on the location (e.g., zip/postal code) of the patient, opportunities based on the location (e.g., zip/postal code) of the healthcare provider associated with the healthcare provider computer 104A or 104B, opportunities based on the patient filling a prescription for the particular medication for the first time, opportunities based on the patient timely refilling a prescription for the particular medication, opportunities based on the income level in the location of the patient, etc. The non-insurance related financial assistance program information and data in the database 182 may then be accessed and evaluated by the financial assistance analysis module 156 or another portion of the service provider computer 106.

With continued reference to FIG. 1, the claims processor computer 108 may be any suitable processor-driven device that facilitates receiving, processing, and/or fulfilling healthcare transactions, such as eligibility verification request, predetermination of benefits transaction, healthcare claim transaction, prescription claim or billing request, healthcare order transaction, or e-prescription transaction (i.e., electronic prescription order transaction, e-script, or e-prescription) received from the service provider computer 106. For example, the claims processor computer 108 may be a processor-driven device associated with a pharmacy benefits manager (PBM), an insurer, a government payor, or a claims clearinghouse. As desired, the claims processor computer 108 may include any number of special purpose computers or other particular machines, application-specific circuits, microcontrollers, personal computers, minicomputers, mainframe computers, servers, and the like.

In certain exemplary embodiments, the operations of the claims processor computer 108 may be controlled by computer-executed or computer-implemented instructions that are executed by one or more processors associated with the claims processor computer 108 to form a special purpose computer or other particular machine that is operable to facilitate the receipt, processing, and/or fulfillment of healthcare transaction requests received from the service provider computer 106. The one or more processors that control the operations of the claims processor computer 108 may be incorporated into the claims processor computer 108 and/or in communication with the claims processor computer 108 via one or more suitable networks. In certain embodiments, the operations and/or control of the claims processor computer 108 may be distributed amongst several processing components.

Similar to other components of the system 100, the claims processor computer 108 may include one or more processors 158, one or more memory devices 160, one or more input/output (“I/O”) interface(s) 162, and one or more network interfaces 164. The one or more memory devices 160 may be any suitable memory devices, for example, caches, read only memory devices, random access memory devices, magnetic storage devices, removable memory devices. The one or more memory devices 160 may store data, executable instructions, and/or various program modules utilized by the claims processor computer 108, for example, data files 166, an operating system (“OS”) 168, a database management system (“DBMS”) 170, and a host module 172. The data files 166 may include any suitable information that is utilized by the claims processor computer 108 to process healthcare transactions, for example, patient profiles, patient insurance information, other information associated with a patient, information associated with a healthcare provider, etc. The operating system (OS) 168 may be a suitable software module that controls the general operation of the claims processor computer 108. The OS 168 may also facilitate the execution of other software modules by the one or more processors 158, for example, the DBMS 170 and/or the host module 172. The OS 168 may be any currently existing or future-developed operating system including, but not limited to, Microsoft Windows®, Apple OSX™, Linux, Unix, or a mainframe operating system.

The DBMS 170 may be a suitable software module that facilitates access and management of one or more databases that are utilized to store information that is utilized by the claims processor computer 108 in various embodiments of the disclosure. The host module 172 may initiate, receive, process, and/or respond to requests, such as healthcare transactions or claim requests, from the host module 154 of the service provider 106. The claims processor computer 108 may include additional program modules for performing other pre-processing or post-processing methods described herein. Those of ordinary skill in the art will appreciate that the claims processor 108 computer may include alternate and/or additional components, hardware or software without departing from the example embodiments described herein.

The one or more I/O interfaces 162 may facilitate communication between the claims processor computer 108 and one or more input/output devices, for example, one or more user interface devices, such as a display, keypad, control panel, touch screen display, remote control, microphone, etc. that facilitate user interaction with the claims processor computer 108. The one or more network interfaces 164 may facilitate connection of the claims processor computer 108 to one or more suitable networks, for example, the network 110. In this regard, the claims processor computer 108 may receive healthcare transactions and/or other communications from the service provider computer 106 and the claims processor computer 108 may communicate information associated with processing the healthcare transactions to the service provider computer 106.

The network 110 may include any telecommunication and/or data network, whether public, private, or a combination thereof, including a local area network, a wide area network, an intranet, the Internet, intermediate hand-held data transfer devices, and/or any combination thereof and may be wired and/or wireless. The network 110 may also allow for real-time, off-line, and/or batch transactions to be transmitted between or among the healthcare provider computers 104A and 104B, the service provider computer 106, and/or the claims processor computer 108. Due to network connectivity, various methodologies, as described herein may be practiced in the context of distributed computing environments. Although the service provider computer 106 is shown for simplicity as being in communication with the healthcare provider computers 104A and 104B, or the claims processor computer 108 via one intervening network 110, it is to be understood that any other network configuration is possible. For example, intervening network 110 may include a plurality of networks, each with devices such as gateways and routers for providing connectivity between or among networks 110. Instead of or in addition to a network 110, dedicated communication links may be used to connect the various devices in accordance with an example embodiment. For example, the service provider computer 106 may form the basis of network 110 that interconnects one or more of the healthcare provider computers 104A and 104B and the claims processor computer 108.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one exemplary embodiment, the service provider computer 106 (or other computer) may be implemented as a specialized processing machine that includes hardware and/or software for performing the methods described herein. In addition, at least a portion of the processor and/or processing capabilities of the service provider computer 106 may be implemented as part of the claims processor computer 108 the pharmacy computer 104A, or the prescriber computer 104B. Accordingly, the exemplary embodiments described herein should not be construed as being limited to any particular operating environment, system architecture, or device configuration.

Operational Overview

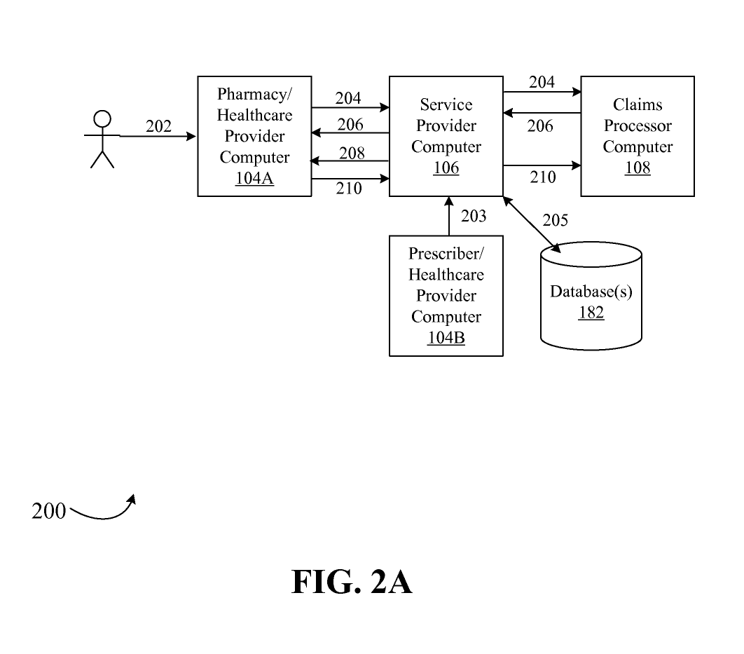

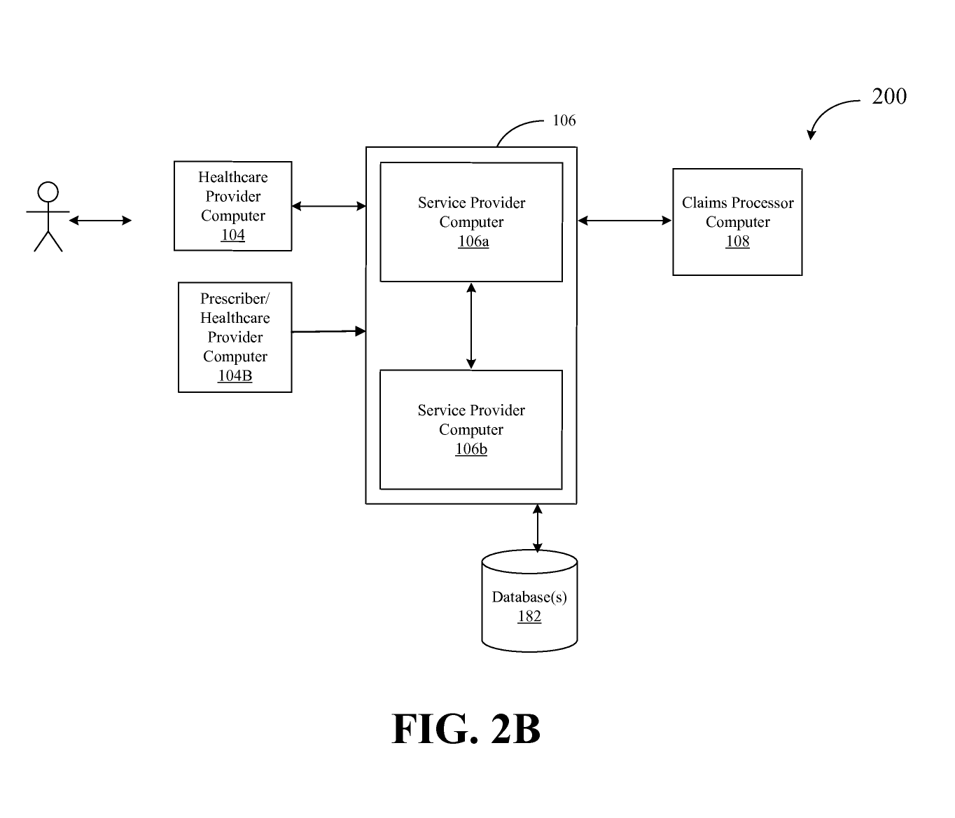

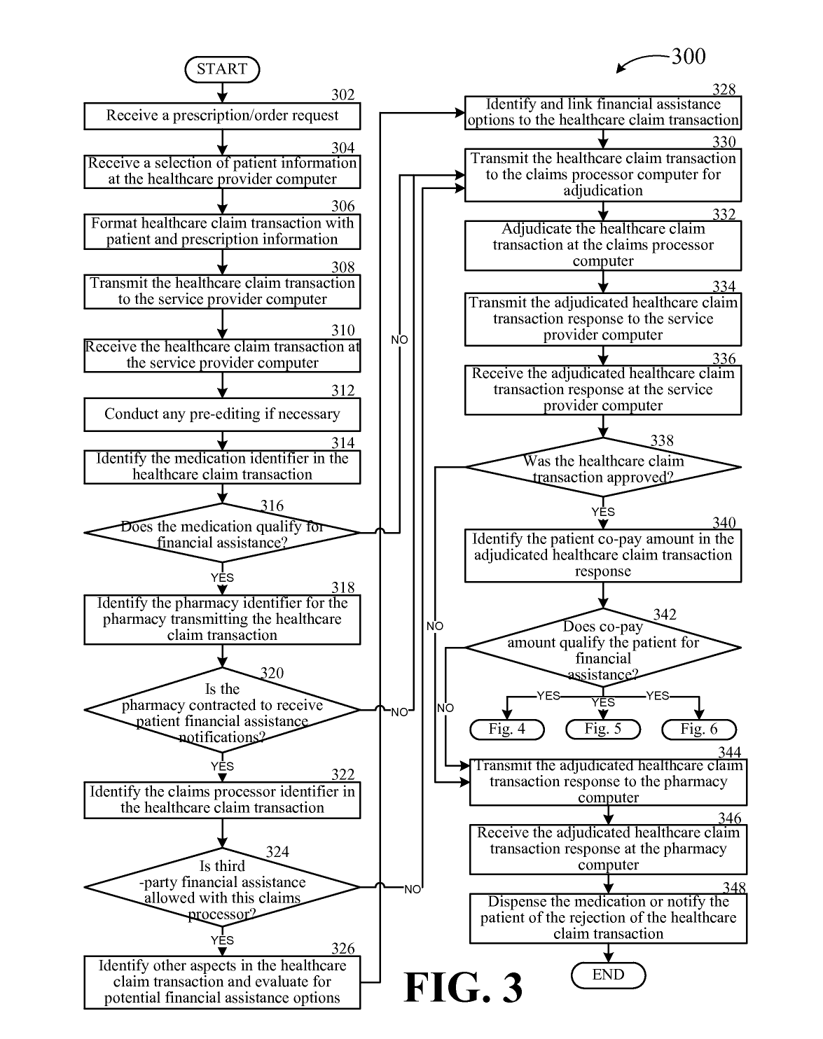

FIG. 2A is a diagram of one example data flow 200 for determining if non-insurance related financial assistance is available for a patient receiving a medication and notifying the patient of the financial assistance opportunities available as part of the processing of a healthcare transaction through a service provider computer, such as through the service provider computer 106 illustrated in FIG. 1. FIG. 3 is a flow chart of an example method 300 for determining if non-insurance related financial assistance is available for a patient receiving a medication as part of the processing of a healthcare transaction (e.g., an eligibility verification request, predetermination of benefits transaction, a healthcare claim transaction, prescription claim or billing request, healthcare order transaction, or e-prescription transaction (i.e., electronic prescription order transaction, e-script, or e-prescription)) through the service provider computer 106, in accordance with one exemplary embodiment.

All or a portion of the steps in the exemplary method 300, described below, may be performed by a suitable service provider computer 106. The exemplary methods 300-700 will be described with reference to a pharmacy as the healthcare provider (and accordingly a pharmacy computer as the healthcare provider computer 104A); however, this is only for purposes of example as any other healthcare provider could be substituted for, and should each be individually read as being a part of each of these methods. As such, where the discussion of the methods below and the drawings state a pharmacy or pharmacy computer 104A, any other healthcare provider and associated healthcare provider computer 104 could be substituted, such as a physician, hospital, physician's office, clinic, or healthcare center.

In addition, the exemplary method 300 will be described with reference to a healthcare claim transaction; however, this also is only for purposes of example as other healthcare transactions, which may include, for example, an eligibility verification request, predetermination of benefits transaction, the healthcare claim transaction, prescription claim or billing request, healthcare order transaction, or e-prescription transaction (i.e., electronic prescription order transaction, e-script, or e-prescription) could be substituted for the healthcare claim transaction and each form of healthcare transaction should each individually be read as being used in the method described below.

Referring now to FIGS. 1, 2A, and 3, the exemplary method 300 begins at the START step and proceeds to step 302, where a prescription/order request 202 is received. In one example embodiment, the prescription/order request 202 is received by a pharmacist at a pharmacy. The prescription/order request 202 may be received from a patient, another healthcare provider prescribing a medication or service (e.g., physician, hospital, etc.), by phone, via the Internet, via an electronic prescription (i.e., electronic prescription order transaction, e-script, or e-prescription) or by way of an electronic system order. For example, the prescription 202 may be received by the patient from a prescriber of the medication, such as a doctor, dentist, nurse, or physician's assistant. The patient may go to the location of the pharmacy and physically hand the prescription request 202 to the pharmacist or make a request via a web portal communicably coupled to the healthcare provider computer 104 or an IVR communicably coupled or otherwise providing order data to the healthcare provider computer 104. The pharmacist determines the patient's name and accesses the healthcare provider computer 104, which receives a selection of patient information from the pharmacist via the I/O interface 128 in step 304. For example, the pharmacist accesses the healthcare provider computer 104 and accesses a database of patient information, which may be stored in memory 126 or in another database either local or remote from the healthcare provider computer 104. The pharmacist can then select the name or other patient identification information in the patient information database that matches the name or other identification information of the patient. In certain example embodiments, this information from the database includes the Payor ID/routing information (e.g., Banking Identification Number (BIN) Number, BIN Number and Processor Control Number (PCN), and/or BIN Number and Group ID) that identifies the claims processor computer 108 intended to receive and adjudicate the healthcare claim transaction 204.

In step 306, a healthcare claim transaction 204 is generated and/or formatted at the healthcare provider computer 104. In certain exemplary embodiments, the healthcare provider computer 104 formats the healthcare claim transaction 204 with patient information, Payor ID/routing information, and medication information. The information can be input into the healthcare claim transaction 204 by the pharmacist via the I/O interface 128 or automatically retrieved and entered by the healthcare provider computer 104 based at least in part on historical transaction information for the patient in the data files 132 or a database communicably coupled to the healthcare provider computer 104. According to one example embodiment, the healthcare claim transaction 204 may be formatted in accordance with a version of the National Council for Prescription Drug Programs (NCPDP) Telecommunication Standard, although other standards may be utilized as well.

As discussed above, the healthcare claim transaction 204 may include a BIN Number, a BIN Number and PCN, and/or a BIN Number and Group ID for identifying a particular claims processor computer (i.e., PBM, payor, healthcare insurance company, Medicare or other government healthcare insurance payor, Medicare Part D provider, etc.), such as the claims processor computer 108, as a destination for the healthcare claim transaction 204. In addition, the healthcare claim transaction 204 may also include information relating to the patient, payor, prescriber, healthcare provider, and/or the requested medication. As an example, the healthcare claim transaction 204 may include one or more of the following information:

Payor ID/Routing Information
BIN Number (i.e. Banking Identification Number), BIN Number and Processor Control Number (PCN) and/or BIN Number and Group ID, that designates a destination of the healthcare claim transaction 204

Patient Information
Name (e.g. Patient Last Name, Patient First Name, etc.)
Date of Birth of Patient
Age of Patient
Gender
Patient Address (e.g. Street Address, Zip Code, etc.)
Patient Contact Information (e.g. patient telephone number, email address, etc.)
Patient Health Condition Information
Patient ID or other identifier (e.g., Health Insurance Claim Number (HICN), social security number, etc.)

Insurance/Coverage Information
Cardholder Name (e.g. Cardholder First Name, Cardholder Last Name)
Cardholder ID and/or other identifier (e.g. person code)
Group ID and/or Group Information

Prescriber Information
Primary Care Provider ID or other identifier (e.g. NPI code)
Primary Care Provider Name (e.g. Last Name, First Name)
Prescriber ID or other identifier (e.g. NPI code, DEA number)
Prescriber Name (e.g. Last Name, First Name)
Prescriber Contact Information (e.g. Telephone Number)
Pharmacy or other Healthcare Provider Information (e.g. store name, chain identifier, etc.)
Pharmacy or other Healthcare Provider ID (e.g. NPI code)

Claim Information
Drug, service, or product information (e.g. National Drug Code (NDC) code, RxNorm code, etc.)
Prescription/Service Reference Number
Date Prescription Written
Quantity Dispensed
Days' Supply
Diagnosis/Condition (e.g., diagnosis code)
Pricing information for the drug/service/product (e.g. network price, Usual & Customary price)
Number of Refills Authorized
One or more NCPDP Message Fields
One or more Drug Utilization (DUR) Codes
Date of Service.

The healthcare claim transaction 204 can be used to determine if the claims processor associated with the claims processor computer 108 approves or rejects payment coverage for medication being requested in the healthcare claim transaction 204 and, if approved, the amount the claims processor will cover (or pay) for the medication being requested and how much the patient co-pay amount will be. Alternatively, in situations where the healthcare transaction is a e-prescription transaction (i.e., electronic prescription order transaction, e-script, or e-prescription) the transaction can be used to transmit a prescription from the prescriber, via the prescriber computer 104B, to the pharmacy, via the pharmacy computer 104A.

The healthcare provider computer 104 transmits the healthcare claim transaction 204 to the service provider computer 106 in step 308. In step 310, the service provider computer 106 receives the healthcare claim transaction 204. For example, the healthcare claim transaction 204 can be transmitted by the healthcare provider computer 104 to the service provider computer 106 through the network 110. The service provider computer 106 conducts any pre-editing, if necessary, on the healthcare claim transaction 204 in step 312. The pre-edits may include verifying, adding, and/or editing information included in the healthcare claim transaction 204 prior to it being communicated to a claims processor computer 108 or the pharmacy computer 104A. For example, the service provider computer 106 can parse the healthcare claim transaction 204 to determine/edit the financial fields, the service code, the quantity dispensed, and or the patient age. In addition, the service provider computer can determine whether non-insurance related financial assistance, (e.g., an incentive program, such as a coupon, voucher, rebate, discount, loyalty award, or other equivalent non-insurance benefit or the like) is available for the patient and/or medication identified in the healthcare claim transaction 204 as discussed below.

In step 314, the financial analysis assistance module 156 or another portion of the service provider computer 106 can identify the medication identifier in the healthcare claim transaction 204. For example, the financial assistance analysis module 156 may parse the healthcare claim transaction 204 to determine the medication identifier (e.g., NDC code or RxNorm code). In step 316, an inquiry is conducted to determine if the medication identified in the healthcare claim transaction 204 qualifies for non-insurance related financial assistance. In one example embodiment, the determination can be made by the financial assistance analysis module 156 or another portion of the service provider computer 106. In one example, the financial assistance analysis module 156 may compare the identified medication identifier from the healthcare claim transaction 204 to a table, schedule, or listing of records containing medication identifiers in, for example, the database 182 or the data files 148 for medications that have non-insurance related financial assistance opportunities available to determine if a match of medication identifiers exists. If a match does not exist and the medication does not have any non-insurance related financial assistance at this time, the NO branch is followed to step 330. If a match does exist and the medication does have opportunities for non-insurance related financial assistance, the YES branch is followed optionally to one of steps 318, 322, 326, and/or 328 depending on the types of evaluations the particular financial assistance opportunities may require or are desired.

In step 318, the financial analysis assistance module 156 or another portion of the service provider computer 106 can identify the pharmacy identifier in the healthcare claim transaction 204. For example, the financial assistance analysis module 156 may parse the healthcare claim transaction 204 to determine the pharmacy identifier (e.g., NPI code). In step 320, an inquiry is conducted to determine if the pharmacy identified by the pharmacy identifier in the healthcare claim transaction 204 has contracted with the service provider associated with the service provider computer 106 to receive non-insurance related financial assistance notifications for its patients/customers. In one example embodiment, the determination can be made by the financial assistance analysis module 156 or another portion of the service provider computer 106. In one example, the financial assistance analysis module 156 may compare the identified pharmacy identifier from the healthcare claim transaction 204 to a table, schedule, or listing of records containing pharmacy identifiers in, for example, the database 182 or the data files 148 for pharmacies or pharmacy chains that have contracted for its patients/customers to receive the non-insurance related financial assistance opportunity notifications to determine if a match of pharmacy identifiers exists. If a match does not exist and the pharmacy has not contracted to receive non-insurance related financial assistance notification services for its patients/customers, the NO branch is followed to step 330. If a match does exist and the pharmacy has contracted for its patients/customers to receive non-insurance related financial assistance opportunity notifications, then the YES branch is followed optionally to one of steps 322, 326, and/or 328 depending on the types of evaluations the particular financial assistance opportunities may require or are desired.

In step 322, the financial analysis assistance module 156 or another portion of the service provider computer 106 can identify the payor identifier (e.g., identifier the designates the claims processor computer 108 to adjudicate the healthcare claim transaction (i.e., BIN Number, BIN Number and PCN, or BIN Number and Group ID) in the healthcare claim transaction 204. For example, the financial assistance analysis module 156 may parse the healthcare claim transaction 204 to determine the payor identifier. In step 324, an inquiry is conducted to determine if third-party financial assistance, such as non-insurance related financial assistance is permitted for members/patients having a plan with the payor/claims processor identified by the payor identifier in the healthcare claim transaction 204.

While patients obviously like to receive addition non-insurance related financial assistance that will either reduce/eliminate the cost or co-pay of their current purchase or provide for a reduction in cost or co-pay for a subsequent or additional purchase, in certain situations the patient may not be allowed to receive the non-insurance related financial assistance. One notable example of not permitting discounts/vouchers is for patients who are participants in a government-funded healthcare insurance program, such as Medicare, Medicaid, or other government healthcare insurance program. In fact, not only are patients not allowed to receive an incentive program if they are participants in a government-funded healthcare insurance program, providing an incentive program in error to these patients can result in the government-funded healthcare insurance program denying payment for the medication or service in the related healthcare transaction.

In one example embodiment, the determination can be made by the financial assistance analysis module 156 or another portion of the service provider computer 106. In one example, the financial assistance analysis module 156 may compare the identified payor identifier from the healthcare claim transaction 204 to a table, schedule, or listing of records containing payor identifiers in, for example, the database 182 or the data files 148 for payors/claims processors that are Medicare, Medicaid, another government-funded healthcare insurance program or another insurance program that does not permit non-insurance related financial assistance to be provided to members/patients under its plan to determine if a match of payor identifiers exists. If a match does not exist and the payor/claims processor is one that permits non-insurance related financial assistance to be provided to members/patients under its plan, the YES branch is followed optionally to one of steps 326 and/or 328 depending on the types of evaluations the particular financial assistance opportunities may require or are desired. If a match does exist and the payor/claims processor is one that does not permit non-insurance related financial assistance to be provided to members/patients under its plan, then the NO branch is followed to step 330.

In step 326, the financial assistance analysis module 156 or another portion of the service provider computer 106 may identify other aspects in the healthcare claim transaction and evaluate those aspects to determine if they trigger and/or limit non-insurance related financial assistance opportunities for the patient. For example, certain patient information (e.g., patient date of birth (patient age) patient zip/postal code, patient gender), the prescriber identifier, a determination of whether the identified patient is receiving the medication for the first time or getting a refill, a determination of whether the patient is requesting the refill in a timely manner, and the like may be aspects that individually or in any combination here or with the prior steps may be used to determine if non-insurance related financial assistance opportunities exist for the patient. In step 328, the financial assistance analysis module 156 may identify the non-insurance related financial assistance opportunities that are available for the patient. The module 156 can link or otherwise associate the identified opportunities to/with the healthcare claim transaction 204. For example the financial assistance analysis module 156 may link/associate the identified opportunities with a prescription reference number or other unique identifier for the healthcare claim transaction 204.

The service provider computer 106 transmits the healthcare claim transaction 204 to the claims processor computer 108 in step 330. For example, a healthcare claim transaction 204 can be transmitted from the service provider computer 106 to the claims processor computer 108 via the network 110. The claims processor computer 108 receives and adjudicates the healthcare claim transaction 204 in step 332 to determine if the patient has coverage, to determine to what extent the patient's coverage covers the requested medication identified in the transaction 204, and to generate an adjudication 206 as to whether the transaction 204 is approved or rejected. Example transaction responses in the adjudicated healthcare claim transaction response 206 can include, but are not limited to, accepted, approved, paid, captured, denied, and denied with request for additional information and resubmission. In certain exemplary embodiments, the transaction responses can be input into a field of the healthcare claim transaction 204 that is recognized by the service provider computer 106 and/or the healthcare provider computer 104. Typically, if the transaction response for the transaction 204 is approved, the adjudicated healthcare claim transaction response 206 provides the amount of the cost of the medication, product, or service that will be covered by the claims processor associated with the claims processor computer 108 and the patient co-pay amount and if the transaction response is a rejection, the adjudicated response 206 provides the reason for the rejection (e.g., in the form of a reject code, for example, patient not covered, Cardholder ID submitted in the transaction is inactive, prior authorization required, medication not covered, etc.).

In step 334, the claims processor computer 108 transmits the adjudicated healthcare claim transaction response 206 to the service provider computer 106 via, for example, the network 110. The service provider computer 106 receives the adjudicated healthcare claim transaction response 206 from the claims processor computer 108 in step 336. In step 338, an inquiry is conducted to determine if the adjudicated healthcare claim transaction response 206 has a transaction response indicating that the transaction 204 was approved or paid. In one exemplary embodiment, the financial assistance analysis module 156 or another portion of the service provider computer 106 parses the adjudicated healthcare claim transaction response 206 and identifies the code in the field associated with the transaction response. The service provider computer 106 compares that identified code to a table of transaction response codes in, for example, the database 182 or the data files 148 to determine the transaction response from the claims processor computer 108 to identify a match. If the transaction response by the claims processor computer 108 is that the healthcare claim transaction 204 is approved or paid, the YES branch is followed to step 340. On the other hand, if the transaction response for the healthcare claim transaction 204 was denied or not paid, the NO branch is followed to step 344.

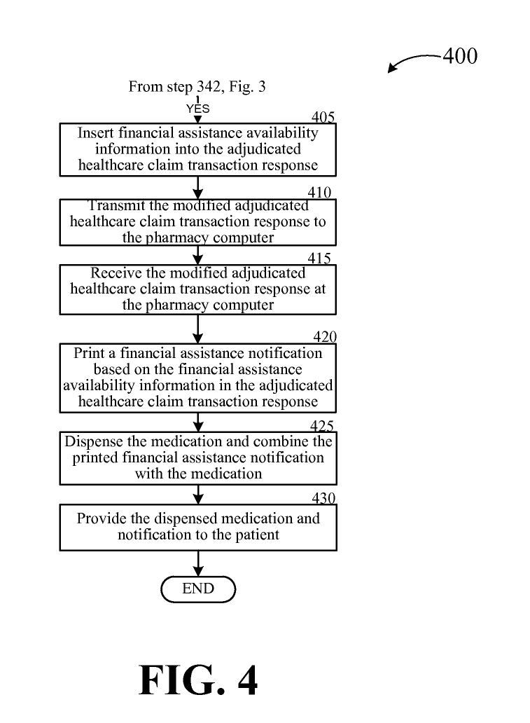

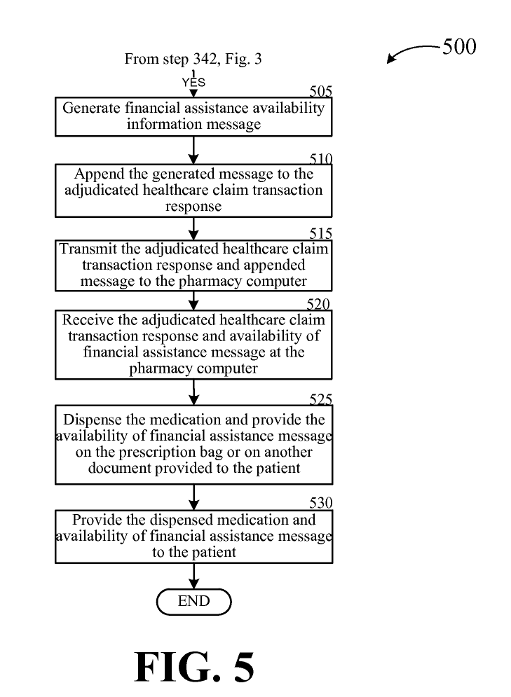

In step 340, the financial assistance analysis module 156 may identify the patient co-pay amount in the adjudicated healthcare claim transaction response 206. For example, the financial assistance analysis module 156 or another portion of the service provider computer 106 parses the adjudicated healthcare claim transaction response 206 and identifies the patient co-pay field and retrieves or otherwise determines the amount therein. In step 342, an inquiry is conducted to determine if the patient co-pay amount qualifies the patient for one or more non-insurance related financial assistance opportunities. In one example embodiment, the determination can be made by the financial assistance analysis module 156 or another portion of the service provider computer 106. For example, certain non-insurance related financial assistance opportunities may be based on the amount of the patient co-pay. Other opportunities may have different levels of non-insurance related financial assistance based on the patient co-pay amount. In certain example embodiments, the patient co-pay amount can be compared to patient co-pay parameters for receiving those linked opportunities from step 328 above. In addition, the patient co-pay amount can be compared to other non-insurance related financial assistance opportunities. If the patient co-pay amount qualifies the patient for non-insurance related financial assistance, the YES branch is followed optionally to one or more of FIGS. 4, 5, and/or 6 for notification of the opportunities identified. In an alternative embodiment, steps 340-342 are optional or not completed and the YES branch from step 338 proceeds optionally to one or more of FIGS. 4, 5, and/or 6. If the patient co-pay amount does not qualify the patient for non-insurance related financial assistance, the NO branch is followed to step 344.

In step 344, the service provider computer 106 transmits the adjudicated healthcare claim transaction response 206 to the pharmacy computer 104A. In one exemplary embodiment, the adjudication healthcare claim transaction response 206 is transmitted to the pharmacy computer 104A via the network 110. The adjudicated healthcare claim transaction response 206 is received by the pharmacy computer 104A in step 346. If the transaction 204 was approved/paid and the parties agree to the financial requirements set forth in the response, the pharmacist or other pharmacy employee may dispense the medication to the patient. If the transaction was denied, the pharmacist or other pharmacy employee may inform the patient of the denial and the basis for the denial included in the adjudicated healthcare claim transaction response 206. The process then continues to the END step.

FIG. 4 is a flow chart of an example method 400 for notifying the patient of the financial assistance opportunities available as part of the processing of a healthcare claim transaction 204, in accordance with one exemplary embodiment of the disclosure. Referring now to FIGS. 1, 2A, 3, and 4, the exemplary method 400 begins at step 405, where the financial assistance analysis module 156 can modify the adjudicated healthcare claim transaction response 206 by inserting information identifying the non-insurance related financial assistance opportunities identified for the patient into the adjudicated healthcare claim transaction response 206. For example, the financial assistance analysis module may insert the information identifying the non-insurance related financial assistance opportunities into a text field of the adjudicated healthcare claim transaction response 206. Alternatively, one or more codes can be created to identify the particular non-insurance related financial assistance opportunities and the code for the ones identified for the patient can be inserted into one or more predetermined fields of the adjudicated healthcare claim transaction response 206. For example, a code “991” can be inserted into a field of the adjudicated healthcare claim transaction response 206 to represent that an electronic coupon is available for the patient. In another example, the data string “991-M35-12” can be inserted into a field of the adjudicated healthcare claim transaction response 206 to notify the pharmacy and patient that an electronic coupon for the patient is available, the maximum benefit of the coupon is $35, and the coupon is good (does not expire) for twelve months. Many other codes and/or strings are contemplated and the ones provided are simply for purposes of example.

In step 410, the service provider computer 106 transmits the modified adjudicated healthcare claim transaction response 206 to the pharmacy computer 104A via, for example, the network 110. The modified adjudicated healthcare claim transaction response 206 is received by the pharmacy computer 104A in step 415. In step 420, the pharmacy computer 104A can print the non-insurance related financial assistance notification that was provided in the modified adjudicated healthcare claim transaction response 206. For example, the code for the opportunity can be identified by the pharmacy computer 104A, which can determine the details of the opportunity and print out the details at a printer communicably coupled to the pharmacy computer 204A. In step 425, the pharmacist or other pharmacy employee may dispense the medication and combine the dispensed medication with the printed non-insurance related financial assistance notification opportunity information. The pharmacist or other pharmacy employee may then provide the dispensed medication and the printed details of the non-insurance related financial assistance opportunity to the patient in step 430. Subsequently the patient, based on the provided details may take one or more actions to obtain the non-insurance related financial assistance opportunity, for example, without involvement of the pharmacy, service provider and/or claims processor. The process then continues to the END step.

FIG. 5 is a flow chart of another example method 500 for notifying the patient of the non-insurance related financial assistance opportunities available as part of the processing of a healthcare claim transaction 204, in accordance with one exemplary embodiment of the disclosure. Referring now to FIGS. 1, 2A, 3 and 5, the exemplary method 500 begins at step 505, where the financial assistance analysis module 156 can generate a message for the identified non-insurance related financial assistance opportunities for the patient. In one example embodiment, the message can be generated by the financial assistance analysis module 156 or another portion of the service provider computer 106. As an example, the generated message may state “Patient financial assistance, up to $35 per 30 day prescription per month, available for this medication from the manufacturer. Access www.[name of medication]/copay_help for additional information.” This message is for example only and can be individually tailored based on the particular opportunity or groups of opportunities. Alternatively, one or more codes can be created to identify each of the particular non-insurance related financial assistance opportunities and the code for the ones identified for the patient can be appended to the response 206 or into one or more predetermined fields of the adjudicated healthcare claim transaction response 206. In certain example embodiments, the messages and/or codes can be prepared and stored in the database 182 and/or data files 148 and can be accessed and retrieved by the financial assistance analysis module 156 when an opportunity is identified.

In step 510, the generated and/or retrieved message/code identifying the non-insurance related financial assistance opportunity can be appended to or into the adjudicated healthcare claim transaction response 206 by, for example, the financial assistance analysis module 156. For example, the financial assistance analysis module 156 may append the message or code for the identified opportunity by generating a separate document that is transmitted with or at substantially the same time as the adjudicated response 206 to the pharmacy computer 104A.

In step 515, the service provider computer 106 transmits the adjudicated healthcare claim transaction response 206 and the appended message/code containing the identified non-insurance related financial assistance opportunity to the pharmacy computer 104A via, for example, the network 110. The adjudicated healthcare claim transaction response 206 and appended message/code is received by the pharmacy computer 104A in step 520. In step 525, the pharmacist or other pharmacy employee may dispense the medication identified in the healthcare claim transaction 204. In addition, the pharmacist or other pharmacy employee can provide the information from the appended message/code regarding the opportunity for financial assistance to the patient. For example, the pharmacist may display the availability of non-insurance related financial assistance opportunities on the prescription bag containing the medication or on another document that can be presented (e.g., one printed out by the pharmacy computer 104A) to the patient. In step 530, the pharmacist or other pharmacy employee may then provide the dispensed medication and the information regarding the non-insurance related financial assistance opportunity to the patient. Subsequently the patient, based on the provided details may take one or more actions to obtain the non-insurance related financial assistance opportunity, for example, without involvement of the pharmacy, service provider, and/or claims processor. The process then continues to the END step.

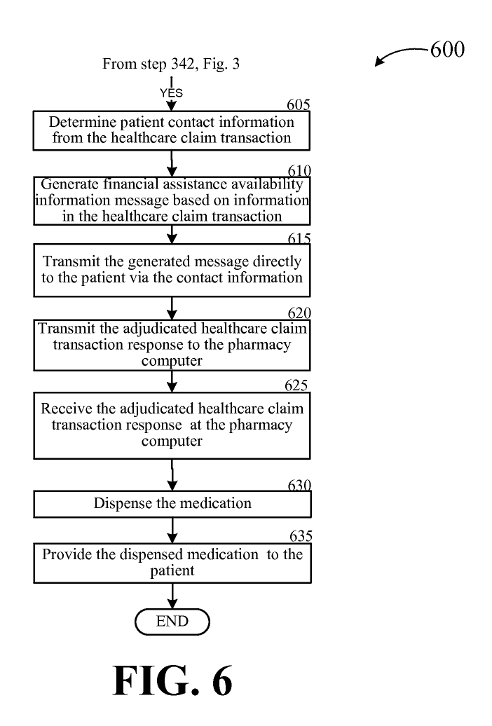

FIG. 6 is a flow chart of yet another example method 600 for notifying the patient of the non-insurance related financial assistance opportunities available to the patient as part of the processing of a healthcare claim transaction 204, in accordance with one exemplary embodiment of the disclosure. Now referring to FIGS. 1, 2A, 3, and 6, the exemplary method 600 begins at step 605, where the financial assistance analysis module 156 can determine patient contact information from the healthcare claim transaction 204. In certain example embodiments, the patient contact information may include the phone number and/or email address of the patient. For example, the financial assistance analysis module 156 or another portion of the service provider computer 106 can parse the healthcare claim transaction 204 to identify the patient contact information in a predetermined field of the transaction 204.

In step 610, the financial assistance analysis module 156 can generate a message for the identified non-insurance related financial assistance opportunities for the patient. As an example, the generated message may be similar to that described in FIG. 5. This message can be individually tailored based on the particular opportunity or groups of opportunities identified for the patient and based on other information in the healthcare claim transaction 204. In certain example embodiments, the messages can be prepared and stored in the database 182 and/or data files 148 and can be accessed and retrieved by the financial assistance analysis module 156 when an opportunity is identified and the message needed. In step 615, the generated or retrieved message is transmitted to the patient based on the identified contact information. For example, if the contact information is an email address for the patient, the financial assistance analysis module 156 or another portion of the service provider computer 106 can transmit the message via the network 110 to the patient as an email message. In another example where the contact information is a phone number for the patient, the financial assistance analysis module 156 transmits the message via the network 110 to the patient as a text message (e.g., SMS, MMS, etc.). In yet another example where the contact information is the phone number for the patient, the financial assistance analysis module 156 can submit the message via an interactive voice response (IVR) or call messaging system that can call the patient at the identified phone number and vocalize the message automatically to the patient or leave a voice message that includes the opportunity message for the patient. In certain example embodiments, the module 156 and/or service provider computer 106 may first determine if permission has been provided by the patient for direct contact by the service provider. In this example, the permission may be received from the healthcare provider computer 104 or directly from the patient and may be stored in the database 182 or data files 148.

In step 620, the service provider computer 106 transmits the adjudicated healthcare claim transaction response 206 to the pharmacy computer 104A via, for example, the network 110. The adjudicated healthcare claim transaction response 206 is received by the pharmacy computer 104A in step 625. In step 630, the pharmacist or other pharmacy employee may dispense the medication identified in the healthcare claim transaction 204. In step 635, the pharmacist or other pharmacy employee may then provide the dispensed medication to the patient. Subsequently, the patient, based on the provided message in step 615, may take one or more actions to obtain the non-insurance related financial assistance opportunity, for example, without involvement of the pharmacy, service provider, and/or claims processor. The process then continues to the END step.

While each of the notification methods in FIGS. 4-6 have been described individually, in certain example embodiments, more than one may be used and as such, any combination of these notification methods described in FIGS. 4-6 may be employed to notify the patient of non-insurance related financial assistance opportunities related to the healthcare claim transaction.

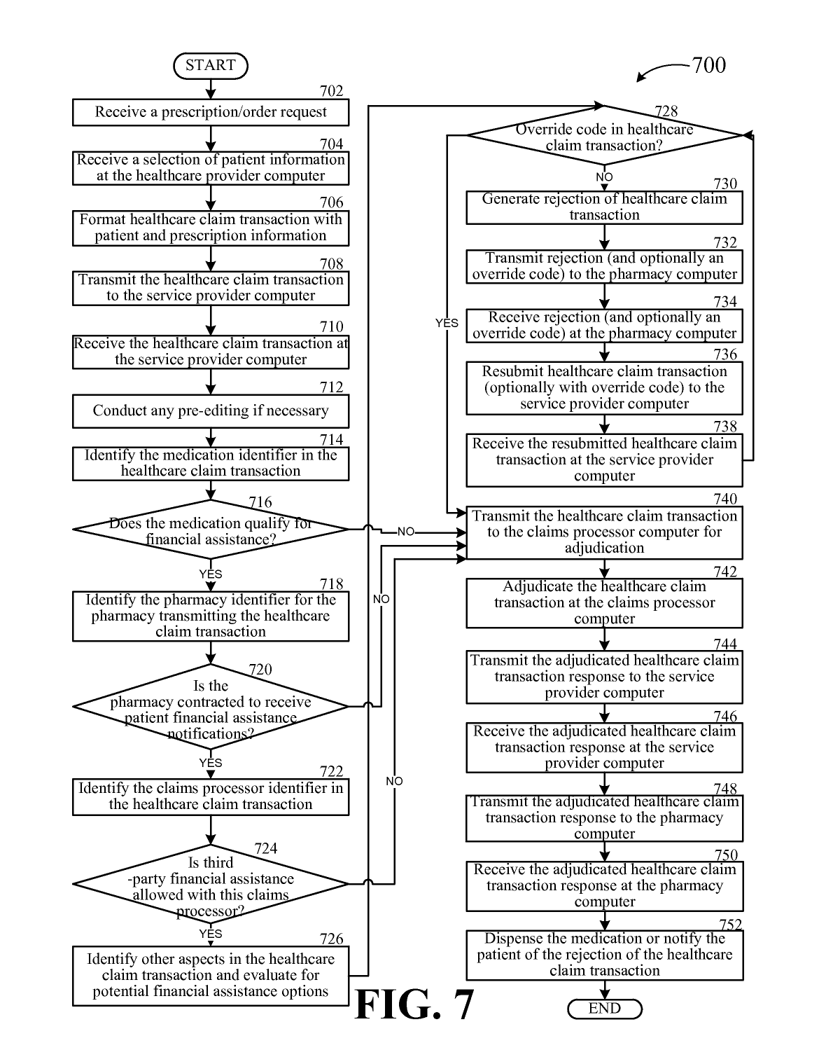

FIG. 7 is a flow chart of another example method 700 for determining if non-insurance related financial assistance is available for a patient receiving a medication and notifying the patient of the financial assistance opportunities available as part of the processing of a healthcare transaction. Referring now to FIGS. 1, 2A, and 7, the exemplary method 700 begins at the START step and proceed to step 702, where a prescription/order request 202 is received. In one example embodiment, the prescription/order request 202 is received by a pharmacist at a pharmacy. The prescription/order request 202 may be received from a patient, another healthcare provider prescribing a medication or service (e.g., physician, hospital, etc.), by phone, via the Internet, via an electronic prescription (i.e., electronic prescription order transaction, e-script, or e-prescription) or by way of an electronic system order. For example, the prescription 202 may be received by the patient from a prescriber of the medication, such as a doctor, dentist, nurse, or physician's assistant. The patient may go to the location of the pharmacy and physically hand the prescription request 202 to the pharmacist or make a request via a web portal communicably coupled to the healthcare provider computer 104 or an IVR communicably coupled or otherwise providing order data to the healthcare provider computer 104. The pharmacist determines the patient's name and accesses the healthcare provider computer 104, which receives a selection of patient information from the pharmacist via the I/O interface 128 in step 704. For example, the pharmacist accesses the healthcare provider computer 104 and accesses a database of patient information, which may be stored in memory 126 or in another database either local or remote from the healthcare provider computer 104. The pharmacist can then select the name or other patient identification information in the patient information database that matches the name or other identification information of the patient. In certain example embodiments, this information from the database includes the Payor ID/routing information (e.g., Banking Identification Number (BIN) Number, BIN Number and Processor Control Number (PCN), and/or BIN Number and Group ID) that identifies the claims processor computer 108 intended to receive and adjudicate the healthcare claim transaction 204.

In step 706, a healthcare claim transaction 204 is generated and/or formatted at the healthcare provider computer 104. In certain exemplary embodiments, the healthcare provider computer 104 formats the healthcare claim transaction 204 with patient information, Payor ID/routing information, and medication information. The information can be input into the healthcare claim transaction 204 by the pharmacist via the I/O interface 128 or automatically retrieved and entered by the healthcare provider computer 104 based at least in part on historical transaction information for the patient in the data files 132 or a database communicably coupled to the healthcare provider computer 104. According to one example embodiment, the healthcare claim transaction 204 may be formatted in accordance with a version of the National Council for Prescription Drug Programs (NCPDP) Telecommunication Standard, although other standards may be utilized as well.

As discussed above, the healthcare claim transaction 204 may include a BIN Number, a BIN Number and PCN, and/or a BIN Number and Group ID for identifying a particular claims processor computer (i.e., PBM, payor, healthcare insurance company, Medicare or other government healthcare insurance payor, Medicare Part D provider, etc.), such as the claims processor computer 108, as a destination for the healthcare claim transaction 204. In addition, the healthcare claim transaction 204 may also include information relating to the patient, payor, prescriber, healthcare provider, and/or the requested medication. As an example, the healthcare claim transaction 204 may include one or more of the following information:

Payor ID/Routing Information
BIN Number (i.e. Banking Identification Number), BIN Number and Processor Control Number (PCN) and/or BIN Number and Group ID, that designates a destination of the healthcare claim transaction 204

Patient Information
Name (e.g. Patient Last Name, Patient First Name, etc.)
Date of Birth of Patient
Age of Patient
Gender
Patient Address (e.g. Street Address, Zip Code, etc.)
Patient Contact Information (e.g. patient telephone number, email address, etc.)
Patient Health Condition Information
Patient ID or other identifier (e.g., Health Insurance Claim Number (HICN), social security number, etc.)

Insurance/Coverage Information
Cardholder Name (e.g. Cardholder First Name, Cardholder Last Name)
Cardholder ID and/or other identifier (e.g. person code)
Group ID and/or Group Information

Prescriber Information
Primary Care Provider ID or other identifier (e.g. NPI code)
Primary Care Provider Name (e.g. Last Name, First Name)
Prescriber ID or other identifier (e.g. NPI code, DEA number)
Prescriber Name (e.g. Last Name, First Name)
Prescriber Contact Information (e.g. Telephone Number)
Pharmacy or other Healthcare Provider Information (e.g. store name, chain identifier, etc.)
Pharmacy or other Healthcare Provider ID (e.g. NPI code)

Claim Information
Drug, service, or product information (e.g. National Drug Code (NDC) code, RxNorm code, etc.)
Prescription/Service Reference Number
Date Prescription Written
Quantity Dispensed
Days' Supply
Diagnosis/Condition (e.g., diagnosis code)
Pricing information for the drug/service/product (e.g. network price, Usual & Customary price)
Number of Refills Authorized
One or more NCPDP Message Fields
One or more Drug Utilization (DUR) Codes
Date of Service.

The healthcare claim transaction 204 can be used to determine if the claims processor associated with the claims processor computer 108 approves or rejects payment coverage for medication being requested in the healthcare claim transaction 204 and, if approved, the amount the claims processor will cover (or pay) for the medication being requested and how much the patient co-pay amount will be. Alternatively, in situations where the healthcare transaction is an e-prescription transaction (i.e., electronic prescription order transaction, e-script, or e-prescription) the transaction can be used to transmit a prescription from the prescriber, via the prescriber computer 104B, to the pharmacy, via the pharmacy computer 104A.

The healthcare provider computer 104 transmits the healthcare claim transaction 204 to the service provider computer 106 in step 708. In step 710, the service provider computer 106 receives the healthcare claim transaction 204. For example, the healthcare claim transaction 204 can be transmitted by the healthcare provider computer 104 to the service provider computer 106 through the network 110. In step 712, the service provider computer 106 conducts any pre-editing, if necessary, on the healthcare claim transaction 204. The pre-edits may include verifying, adding, and/or editing information included in the healthcare claim transaction 204 prior to it being communicated to a claims processor computer 108 or the pharmacy computer 104A. For example, the service provider computer 106 can parse the healthcare claim transaction 204 to determine/edit the financial fields, the service code, the quantity dispensed, and or the patient age. In addition, the service provider computer can determine whether non-insurance related financial assistance, (e.g., an incentive program, such as a coupon, voucher, rebate, discount, loyalty award, or other equivalent non-insurance benefit or the like) is available for the patient and/or medication identified in the healthcare claim transaction 204 as discussed below.

In step 714, the financial analysis assistance module 156 or another portion of the service provider computer 106 can identify the medication identifier in the healthcare claim transaction 204. For example, the financial assistance analysis module 156 may parse the healthcare claim transaction 204 to determine the medication identifier (e.g., NDC code or RxNorm code). In step 716, an inquiry is conducted to determine if the medication identified in the healthcare claim transaction 204 qualifies for non-insurance related financial assistance. In one example embodiment, the determination can be made by the financial assistance analysis module 156 or another portion of the service provider computer 106. In one example, the financial assistance analysis module 156 may compare the identified medication identifier from the healthcare claim transaction 204 to a table, schedule, or listing of records containing medication identifiers in, for example, the database 182 or the data files 148 for medications that have non-insurance related financial assistance opportunities available to determine if a match of medication identifiers exists. If a match does not exist and the medication does not have any non-insurance related financial assistance at this time, the NO branch is followed to step 740. If a match does exist and the medication does have opportunities for non-insurance related financial assistance, the YES branch is followed optionally to one of steps 718, 722, 726, and/or 728 depending on the types of evaluations the particular financial assistance opportunities may require or are desired.

In step 718, the financial analysis assistance module 156 or another portion of the service provider computer 106 can identify the pharmacy identifier in the healthcare claim transaction 204. For example, the financial assistance analysis module 156 may parse the healthcare claim transaction 204 to determine the pharmacy identifier (e.g., NPI code). In step 720, an inquiry is conducted to determine if the pharmacy identified by the pharmacy identifier in the healthcare claim transaction 204 has contracted with the service provider associated with the service provider computer 106 to receive non-insurance related financial assistance notifications for its patients/customers. In one example embodiment, the determination can be made by the financial assistance analysis module 156 or another portion of the service provider computer 106. In one example, the financial assistance analysis module 156 may compare the identified pharmacy identifier from the healthcare claim transaction 204 to a table, schedule, or listing of records containing pharmacy identifiers in, for example, the database 182 or the data files 148 for pharmacies or pharmacy chains that have contracted for its patients/customers to receive the non-insurance related financial assistance opportunity notifications to determine if a match of pharmacy identifiers exists. If a match does not exist and the pharmacy has not contracted to receive non-insurance related financial assistance notification services for its patients/customers, the NO branch is followed to step 740. If a match does exist and the pharmacy has contracted for its patients/customers to receive non-insurance related financial assistance opportunity notifications, then the YES branch is followed optionally to one of steps 722, 726, and/or 728 depending on the types of evaluations the particular financial assistance opportunities may require or are desired.

In step 722, the financial analysis assistance module 156 or another portion of the service provider computer 106 can identify the payor identifier (e.g., identifier the designates the claims processor computer 108 to adjudicate the healthcare claim transaction (i.e., BIN Number, BIN Number and PCN, or BIN Number and Group ID) in the healthcare claim transaction 204. For example, the financial assistance analysis module 156 may parse the healthcare claim transaction 204 to determine the payor identifier. In step 724, an inquiry is conducted to determine if third-party financial assistance, such as non-insurance related financial assistance is permitted for members/patients having a plan with payor/claims processor identified by the payor identifier in the healthcare claim transaction 204.

In one example embodiment, the determination can be made by the financial assistance analysis module 156 or another portion of the service provider computer 106. In one example, the financial assistance analysis module 156 may compare the identified payor identifier from the healthcare claim transaction 204 to a table, schedule, or listing of records containing payor identifiers in, for example, the database 182 or the data files 148 for payors/claims processors that are Medicare, Medicaid, another government-funded healthcare insurance program or another insurance program that does not permit non-insurance related financial assistance to be provided to members/patients under its plan to determine if a match of payor identifiers exists. If a match does not exist and the payor/claims processor is one that permits non-insurance related financial assistance to be provided to members/patients under its plan, the YES branch is followed optionally to one of steps 726 and/or 728 depending on the types of evaluations the particular financial assistance opportunities may require or are desired. If a match does exist and the payor/claims processor is one that does not permit non-insurance related financial assistance to be provided to members/patients under its plan, then the NO branch is followed to step 740.

In step 726, the financial assistance analysis module 156 or another portion of the service provider computer 106 may identify other aspects in the healthcare claim transaction and evaluate those aspects to determine if they trigger and/or limit non-insurance related financial assistance opportunities for the patient. For example, certain patient information (e.g., patient date of birth (patient age) patient zip/postal code, patient gender), the prescriber identifier, a determination of whether the identified patient is receiving the medication for the first time or getting a refill, a determination of whether the patient is requesting the refill in a timely manner, and the like may be aspects that individually or in any combination here or with the prior steps may be used to determine if non-insurance related financial assistance opportunities exist for the patient.

In step 728, an inquiry is conducted to determine if the healthcare claim transaction 204 includes an override code in one of its fields. For example, the financial assistance analysis module 156 or another portion of the service provider computer 106 may parse the transaction 204 an look in a predetermined field to determine if an override code has been entered. In one example embodiment, the inclusion of an override code in the transaction 204 can represent that the transaction 204 was previously received and processed by the service provider computer 106 and that that transaction was rejected and sent back to the pharmacy computer 104A with the inclusion of non-insurance related financial assistance opportunity information as will be discussed in more detail in steps 730-738 below. The financial assistance analysis module 156 can compare the override code to a stored override code to determine if a match exists and a proper override code has been received. In certain example embodiments, a unique override code is generated by the module 156 and/or the service provider computer 106 for each transaction 204 or prescription number and verification that the correct override code has been received from the pharmacy computer 104A can be made in that manner. If the healthcare claim transaction 204 includes an override code, then the YES branch is followed to step 740. If the healthcare claim transaction 204 does not include an override code, then the NO branch is followed to step 730.

In step 730, the financial assistance analysis module 156 or another portion of the service provider computer 106 may generate a rejection 208 of the healthcare claim transaction 204. The rejection 208 may include a reject code that identifies that the rejection occurred at the service provider computer 106. Further, the rejection 208 may include a message or code generated by the financial assistance analysis module 156 or another portion of the service provider computer 106 that includes an identification of a non-insurance related financial assistance opportunity for the patient. As an example, the generated message may state “Patient financial assistance, up to $35 per 30 day prescription per month, available for this medication from the manufacturer. Access www.[name of medication]/copay_help for additional information.” This message is for example only and can be individually tailored based on the particular opportunity or groups of opportunities. Alternatively, one or more codes can be created to identify each of the particular non-insurance related financial assistance opportunities and the code for the ones identified for the patient can be appended to the rejection 208 or into one or more predetermined fields of the rejection 208 of the healthcare claim transaction response 204. In certain example embodiments, the messages and/or codes can be prepared and stored in the database 182 and/or data files 148 and can be accessed and retrieved by the financial assistance analysis module 156 when an opportunity is identified.

The service provider computer 106 may transmit the rejection 208, and optionally an override code, to the pharmacy computer 104A via, for example, the network 110 in step 732. In one example embodiment, the override code may be included in a predetermined field of the transaction 204 and may be a unique override code to the particular transaction 204 or alternatively may be the same override code for all transactions. In one example, the pharmacist or other pharmacy employee may see the message regarding the non-insurance related financial assistance opportunity for the patient and the override code and provide an indication that they have seen the message regarding the non-insurance related financial assistance opportunity by resubmitting the healthcare claim transaction with the override code.

In step 734, the rejection 208 is received at the pharmacy computer 104A from the service provider computer 106. A resubmitted healthcare claim transaction 210 can be transmitted, optionally with the override code provided with the rejection 208, to the service provider computer 106 in step 736. In step 738, the service provider computer 106 can receive the resubmitted healthcare claim transaction 210 from the pharmacy computer 104A via, for example, the network 110. The process can return to step 728 to determine if the override code is included and if it is the correct override code.

The service provider computer 106 transmits the resubmitted healthcare claim transaction 210 to the claims processor computer 108 in step 740. For example, the resubmitted healthcare claim transaction 210 can be transmitted from the service provider computer 106 to the claims processor computer 108 via the network 110. The claims processor computer 108 receives and adjudicates the resubmitted healthcare claim transaction 210 in step 742 to determine if the patient has coverage, to determine to what extent the patient's coverage covers the requested medication identified in the transaction 210, and to generate an adjudication 206 as to whether the transaction 210 is approved or rejected. Example transaction responses in the adjudicated healthcare claim transaction response 206 can include, but are not limited to, accepted, approved, paid, captured, denied, and denied with request for additional information and resubmission.

In step 744, the claims processor computer 108 transmits the adjudicated healthcare claim transaction response 206 to the service provider computer 106 via, for example, the network 110. The service provider computer 106 receives the adjudicated healthcare claim transaction response 206 from the claims processor computer 108 in step 746. In step 748, the service provider computer 106 transmits the adjudicated healthcare claim transaction response 206 to the pharmacy computer 104A via, for example, the network 110. The adjudicated healthcare claim transaction response 206 is received by the pharmacy computer 104A in step 750. If the transaction 204 was approved/paid and the parties agree to the financial requirements set forth in the response, the pharmacist or other pharmacy employee may dispense the medication to the patient in step 752. If the transaction was denied, the pharmacist or other pharmacy employee may inform the patient of the denial and the basis for the denial included in the adjudicated healthcare claim transaction response 206 in step 752. The process then continues to the END step.

The methods described and shown in FIGS. 3-7 may be carried out or performed in any suitable order as desired in various embodiments. Additionally, in certain exemplary embodiments, at least a portion of the operations may be carried out in parallel. Furthermore, in certain exemplary embodiments, less than or more than the operations described in FIGS. 3-7 may be performed.

Likewise, while FIGS. 3-7 have been described primarily in conjunction with FIG. 2A, it will be appreciated that variations of FIG. 2A are available. As shown by FIG. 2B, the service provider computer 106 may include two or more distinct service provider computers 106a and 106b that are in communication with each other. These distinct service provider computers 106a and 106b may be owned, operated, and or located by the same or distinct and wholly-unrelated companies. The service provider computer 106a may be operative with the healthcare provider computer 104 (A and/or B), while the service provider computer 106b may be operative with other healthcare provider computers and/or other third-party entity computers. However, the service provider computer 106b may have a data processing arrangement with the service provider computer 106a. Under the data processing arrangement, the service provider computer 106a may be permitted to utilize or offer services of the service provider computer 106b, including the operations and use of the financial assistance analysis module 156 and/or the database 182 to identify non-insurance related financial assistance opportunities for patients in real-time or near real-time with the processing of healthcare transactions, as discussed above in FIGS. 3-7. Accordingly, the services accessible by the service provider computer 106b, including the identification of non-insurance related financial assistance opportunities for patients based on information received in the healthcare transaction, may be available to the healthcare provider computer 104 via the service provider computers 106a and 106b.

Similarly, while the example embodiments described in FIGS. 2A-7 describe communication of a healthcare transaction between a pharmacy computer 104A and the claims processor 108 via the service provider computer 106 and the actions taken by the service provider computer 106, other alternative pathways exist. For example, in situations where the healthcare transaction is an e-prescription transaction (i.e., electronic prescription order transaction, e-script, or e-prescription), the initiating system for the transaction 204 can change from the pharmacy computer 104A to the prescriber computer 104B, which transmits the healthcare transaction 204 to the service provider 106. In this example, references to the pharmacy computer 104A in steps 302-310 of FIGS. 3 and 702-710 of FIG. 7 may be amended to reference the prescriber computer 104B. Further, in this example, references to adjudication in steps 330-342 of FIGS. 3 and 740-746 of FIG. 7 may be optional or not completed as part of the example method. Further, in this example, references to including information in (such as the non-insurance related financial assistance opportunities), appending information to, and/or transmitting the adjudicated healthcare claim transaction response 206 may be amended to reference the healthcare transaction (e.g., e-prescription transaction (i.e., electronic prescription order transaction, e-script, or e-prescription)) received by the service provider computer 106 from the prescriber computer 104B. Further, in this alternate example, references to the pharmacy computer 104A and associated pharmacy and pharmacist or pharmacy employees in steps 344-348 of FIG. 3, steps 410-430 of FIG. 4, steps 515-530 of FIG. 5, steps 620-635 of FIG. 6, and steps 748-752 of FIG. 7 may continue to be read in that way (such that the pharmacy computer 104A continues to receive the transaction 204 and optionally a message/code identifying non-insurance related financial assistance opportunities for the patient) or alternatively that the prescriber computer 104B, prescriber, and/or the healthcare provider employee are substituted therein and the prescriber computer 104B receives the transaction 204 that it previously submitted to the service provider computer and the transaction 204 includes a message/code identifying non-insurance related financial assistance opportunities for the patient. The service provider may then conduct the methods described in FIGS. 3-7 to identify and communicate the non-insurance related financial assistance opportunities to the patient in the transaction 204 and transmit that transaction to the pharmacy computer 104A and/or the prescriber computer 104B.

Accordingly, example embodiments disclosed herein can provide the technical effects of creating a system and methods that provide a real-time or near real-time way to automatically determine non-insurance related financial assistance opportunities and generate notifications to the pharmacy/patient in numerous ways in line with or as part of the processing of a healthcare transaction for the patient. In this regard, patients may be notified of ways to save money on prescription products and are more likely to use and/or continue using those prescription products as instructed by a qualified healthcare provider.

While certain example embodiments disclosed herein describe the financial assistance analysis module 156 as being part of the service provider computer 106, in alternate embodiments, the financial assistance analysis module 156 or the functions that it completes may be in a processor-driven device separate and distinct from the service provider computer 106. In those embodiments where the financial assistance analysis module 156 is incorporated into the service provider computer 106, and with regard to the methods described above, the steps describing transmitting or receiving between the service provider computer 106 and the eligibility module 156 may be internal transmissions within the service provider computer 106 or may be omitted altogether. Further, while the exemplary embodiments described herein disclose certain steps occurring at the service provider computer 106 and/or the financial assistance analysis module 156, in alternative embodiments all or a portion of those steps described with reference to FIGS. 1-7 may alternately be completed at a pharmacy computer, prescriber computer, or other healthcare provider computer 104 (e.g., hospital computer, clinic computer, etc.) a claims processor computer 108, any combination thereof, and/or any combination of those devices along with the service provider computer 106. In those alternate embodiments, certain transmission/receiving steps described above with reference to FIGS. 1-7 may be omitted while others may be added, as understood by one or ordinary skill in the art. The intent being that in alternate embodiments, any of the devices/computers discussed in FIG. 1 are capable of completing any or any part of the methods described with reference to FIGS. 2-7.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, that includes a computer usable medium (e.g., transitory or non-transitory) having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
receiving, by one or more computers comprising one or more processors from a claims processor computer associated with a healthcare claims processor, an adjudicated response to a healthcare claim transaction, wherein the adjudicated response provides a benefits determination for the healthcare claim transaction, the adjudicated response comprising a response status and a patient co-pay amount, and the healthcare claim transaction comprising a medication identifier identifying a medication to be prescribed, and at least one patient identifier identifying a patient to receive the prescribed medication;
determining, by the one or more computers, if the patient qualifies for a notification of a non-insurance related financial assistance opportunity, wherein the notification provides information about a non-insurance related financial assistance opportunity but does not modify the patient co-pay amount in the adjudicated response;
generating, by the one or more computers and based at least in part on the determination that the patient qualifies for the notification of the non-insurance related financial assistance opportunity, the notification of the non-insurance related financial assistance opportunity;
transmitting, by the one or more computers, the adjudicated response to a pharmacy computer associated with a pharmacy from which the healthcare claim transaction originated; and
transmitting, by the one or more computers, the notification of the non-insurance related financial assistance opportunity.

2. The computer-implemented method of claim 1, wherein the method further comprises receiving from the pharmacy computer the healthcare claim transaction and wherein determining if the patient qualifies for the notification of the non-insurance related financial assistance opportunity comprises:
identifying, by the one or more computers, the at least one patient identifier in the healthcare claim transaction; and
determining, by the one or more computers, if the patient qualifies for the notification of the non-insurance related financial assistance opportunity based at least in part on the at least one patient identifier.

3. The computer-implemented method of claim 1, wherein the method further comprises receiving from the pharmacy computer the healthcare claim transaction and wherein determining if the patient qualifies for the notification of the non-insurance related financial assistance opportunity comprises:
identifying, by the one or more computers, the medication identifier in the healthcare claim transaction; and
determining, by the one or more computers, if the patient qualifies for the notification of the non-insurance related financial assistance opportunity based at least in part on the identified medication identifier.

4. The computer-implemented method of claim 1, wherein the method further comprises receiving from the pharmacy computer the healthcare claim transaction, wherein the healthcare claim transaction further comprises a payor identifier identifying a claims processor computer associated with a claims processor, and wherein determining if the patient qualifies for the notification of the non-insurance related financial assistance opportunity comprises:
identifying, by the one or more computers, the payor identifier in the healthcare claim transaction; and
determining, by the one or more computers, if the patient qualifies for the notification of the non-insurance related financial assistance opportunity based at least in part on the identified payor identifier.

5. The computer-implemented method of claim 1, wherein determining if the patient qualifies for the notification of the non-insurance related financial assistance opportunity comprises:
identifying, by the one or more computers, the patient co-pay amount in the adjudicated response to the healthcare claim transaction; and
determining, by the one or more computers, if the patient qualifies for the notification of the non-insurance related financial assistance opportunity based at least in part on the identified patient co-pay amount.

6. The computer-implemented method of claim 1, wherein transmitting the notification of the non-insurance related financial assistance opportunity comprises:
modifying, by the one or more computers, the received adjudicated response by inserting the notification of the non-insurance related financial assistance opportunity into at least one field of the adjudicated response; and
transmitting, by the one or more computers, the modified adjudicated response comprising the notification of the non-insurance related financial assistance opportunity to the pharmacy computer.

7. The computer-implemented method of claim 1, wherein transmitting the notification of the non-insurance related financial assistance opportunity comprises:
determining, by the one or more computers, a patient contact information for the patient;
transmitting, by the one or more computers and based on the patient contact information, the notification of the non-insurance related financial assistance opportunity to the patient.

8. The computer-implemented method of claim 7, wherein the patient contact information is a phone number or an e-mail address.

9. The computer-implemented method of claim 8, wherein the healthcare claim transaction further comprises the patient contact information and wherein determining the patient contact information comprises identifying, by the one or more computers, the patient contact information in the healthcare claim transaction.

10. A system, comprising;
at least one memory operable to store computer-executable instructions; and
at least one processor configured to access the at least one memory and execute the computer-executable instructions to:
receive, from a claims processor computer associated with a healthcare claims processor, an adjudicated response to a healthcare claim transaction, wherein the adjudicated response provides a benefits determination for the healthcare claim transaction, the adjudicated response comprising a response status and a patient co-pay amount, and the healthcare claim transaction comprising a medication identifier identifying a medication to be prescribed, and at least one patient identifier identifying a patient to receive the prescribed medication;
determine if the patient qualifies for a notification of a non-insurance related financial assistance opportunity, wherein the notification provides information about a non-insurance related financial assistance opportunity but does not modify the patient co-pay amount in the adjudicated response;
generate, based at least in part on the positive determination that the patient qualifies for the notification of the non-insurance related financial assistance opportunity, the notification of the non-insurance related financial assistance opportunity;
direct communication of the adjudicated response to a pharmacy computer associated with a pharmacy from which the healthcare claim transaction originated; and
direct communication of the notification of the non-insurance related financial assistance opportunity.

11. The system of claim 10, wherein the at least one processor is further configured to access the at least one memory and execute the computer-executable instructions to:
receive from the pharmacy computer the healthcare claim transaction;
wherein the at least one processor is further configured to determine if the patient qualifies for the notification of the non-insurance related financial assistance opportunity by accessing the at least one memory and executing the computer-executable instructions to:
identify the at least one patient identifier in the healthcare claim transaction; and
determine if the patient qualifies for the notification of the non-insurance related financial assistance opportunity based at least in part on the at least one patient identifier.

12. The system of claim 10, wherein the at least one processor is further configured to access the at least one memory and execute the computer-executable instructions to:
receive from the pharmacy computer the healthcare claim transaction;
wherein the at least one processor is further configured to determine if the patient qualifies for the notification of the non-insurance related financial assistance opportunity by accessing the at least one memory and executing the computer-executable instructions to:
identify the medication identifier in the healthcare claim transaction; and
determine if the patient qualifies for the notification of the non-insurance related financial assistance opportunity based at least in part on the identified medication identifier.

13. The system of claim 10, wherein the at least one processor is further configured to access the at least one memory and execute the computer-executable instructions to:
receive from the pharmacy computer the healthcare claim transaction;
wherein the healthcare claim transaction further comprises a payor identifier identifying a claims processor computer associated with a claims processor, and wherein the at least one processor is further configured to determine if the patient qualifies for the notification of the non-insurance related financial assistance opportunity by accessing the at least one memory and executing the computer-executable instructions to:
identify the payor identifier in the healthcare claim transaction; and
determine if the patient qualifies for the notification of the non-insurance related financial assistance opportunity based at least in part on the identified payor identifier.

14. The system of claim 10, wherein the at least one processor is further configured to determine if the patient qualifies for the notification of the non-insurance related financial assistance opportunity by accessing the at least one memory and executing the computer-executable instructions to:
identify the patient co-pay amount in the adjudicated response to the healthcare claim transaction; and
determine if the patient qualifies for the notification of the non-insurance related financial assistance opportunity based at least in part on the identified patient co-pay amount.

15. The system of claim 10, wherein the at least one processor is further configured to direct communication of the notification of the non-insurance related financial assistance opportunity by accessing the at least one memory and executing the computer-executable instructions to:
modify the received adjudicated response by inserting the notification of the non-insurance related financial assistance opportunity into at least one field of the adjudicated response; and
direct communication of the modified adjudicated response comprising the notification of the non-insurance related financial assistance opportunity to the pharmacy computer.

16. The system of claim 10, wherein the at least one processor is further configured to direct communication of the notification of the non-insurance related financial assistance opportunity by accessing the at least one memory and executing the computer-executable instructions to:
determine a patient contact information for the patient;
direct communication of the notification of the non-insurance related financial assistance opportunity to the patient based on the patient contact information.

17. The system of claim 16, wherein the patient contact information is a phone number or an e-mail address.

18. The system of claim 17, wherein the healthcare claim transaction further comprises the patient contact information and wherein the at least one processor is further configured to determine the patient contact information by accessing the at least one memory and executing the computer-executable instructions to identify the patient contact information in the healthcare claim transaction.

19. A computer-implemented method, comprising:
receiving, by one or more computers comprising one or more processors from a healthcare provider computer associated with a healthcare provider, a healthcare claim transaction, the healthcare claim transaction comprising a medication identifier identifying a medication to be prescribed, and at least one patient identifier identifying a patient to receive the prescribed medication;
determining, by the one or more computers, if the patient qualifies for a notification of a non-insurance related financial assistance opportunity based at least in part on the medication identifier, wherein the notification provides information about a non-insurance related financial assistance opportunity but does not modify the patient co-pay amount in the adjudicated response;
generating, by the one or more computers and based at least in part on the positive determination that the patient qualifies for the notification of the non-insurance related financial assistance opportunity, the notification of the non-insurance related financial assistance opportunity;
generating, by the one or more computers and based at least in part on the positive determination that the patient qualifies for the notification of the non-insurance related financial assistance opportunity, a rejection of the healthcare transaction;
transmitting, by the one or more computers, the rejection of the healthcare and the notification of the non-insurance related financial assistance opportunity to the healthcare provider computer;
receiving, by the one or more computers and from the healthcare provider computer, a resubmitted healthcare transaction, wherein the resubmitted healthcare transaction is associated with the healthcare transaction;
determining, by the one or more computers, if the resubmitted healthcare transaction comprises an override code; and
transmitting, by the one or more computers and based on a positive determination that the resubmitted healthcare transaction comprises the override code, the resubmitted healthcare transaction to one of a claims processor computer associated with a claims processor or a second healthcare provider computer associated with a second healthcare provider different from the first healthcare provider.

20. The computer-implemented method of claim 19, wherein the healthcare transaction is one of a healthcare claim transaction, a prescription claim request, a prescription billing request, a healthcare order transaction, or an e-prescription transaction.
